(19) United States
(12) Patent Application Publication
(10) Pub. No.: US 2024/0228295 A1
(43) Pub. Date: Jul. 11, 2024

(54) A METHOD FOR PRODUCING FLAKED GRAPHENE BY INTERCALATION AND EXFOLIATION OF GRAPHITE

(71) Applicant: POLITECHNIKA WARSZAWSKA, Warszawa (PL)

(72) Inventors: Mariusz Zdrojek, Warszawa (PL); Andrzej Robert Daniewski, Kanie (PL); Anna Duzynska, Warszawa (PL); Milena Ojrzynska, Izabelin (PL)

(73) Assignee: POLITECHNIKA WARSZAWSKA, Warszawa (PL)

(21) Appl. No.: 18/557,563

(22) PCT Filed: Feb. 24, 2022
(86) PCT No.: PCT/IB2022/051634

§ 371 Date: Oct. 26, 2023

(30) Foreign Application Priority Data
Feb. 25, 2021 (PL) P.437127

(51) Int. Cl. C01B 32/19

(52) U.S. Cl. CPC C01B 32/19; C01B 2204/04; C01P 2002/82; C01P 2004/03; C01P 2004/04

(57) ABSTRACT

The object of the invention is a method for producing flaked graphene by intercalation and exfoliation of graphite in a liquid, with continuous stirring of the components by sonication, characterized in that oleum is used as the liquid, wherein the concentration of sulphur trioxide in sulphuric acid is 1-60%.

The present invention relates to a method for producing flaked graphene by intercalation and exfoliation of graphite which enables efficient production of thin graphene flakes having very good quality without defecting their structure.

Graphene is a two-dimensional carbon atom lattice with a hexagonal structure. The carbon atom lattice is connected in a plane by the sp² bonds of 0.142 nm in length, and individual graphene layers in the graphite crystal are located at 0.335 nm distances. A unit cell of the graphene lattice contains two carbon atoms, each of which has 4 valence electrons. Three of these electrons form a strong covalent bond, and the fourth electron, located on an orbital perpendicular to the graphene plane, forms a weaker bond by means of van der Waals forces, due to which individual graphene layers form graphite. The purpose of the exfoliation is to overcome van der Waals interactions and separate individual layers of graphene from each other.

Graphene is both the thinnest and the lightest material with one-atom thickness (1 m² weighs 0.77 mg) and the most durable material (130 GPa and Young's modulus equal to 1 TPa). Additionally, it is a great conductor of heat (4.84-5.30×10³ W·m⁻¹·K⁻¹) and electricity (theoretical electron mobility is over 200,000 cm²V⁻¹s⁻¹). This material is also remarkable for its unique optical absorption which is constant for light in the range from visible to near-infrared (πα˜2.3%). Due to a number of interesting properties, graphene is widely used in manufacturing of various types of electronic, optical and composite systems. Currently, large quantities of graphene are needed in energy conversion and storage technologies, as well as in printed electronics and optoelectronics, and in composite technology. However, the current methods of graphene production available on the market are still complex and expensive, which significantly limits the scope of potential graphene applications. Developing methods of graphene production that would increase a yield and quality of graphene flakes while reducing costs is now crucial for the future of implementations based on this carbon material.

Graphene is known to be obtained by the Liquid-Phase Exfoliation (LPE) method comprising three production steps: dispersion of the material in a liquid, direct exfoliation process (e.g. using ultrasounds), and separation of thin graphene flakes from non-exfoliated graphite. LPE is a method that enables the production of very good quality layers with a low degree of defects, and allows to scale up production processes from laboratory to industrial quantities. KR20160127237 presents the production process of flaked graphene, with converting graphite into graphite oxide (GO) in the first step, and reducing GO to flaked graphene, usually characterized by a high concentration of defects, in the second step. The graphite oxidation process is carried out in 98% sulphuric acid with an addition of 65% nitric acid, and an oxidant is potassium permanganate. This reaction is difficult to control and on a larger scale can even lead to an explosion. Separation of graphite oxide (GO) is also difficult because manganese salts have to be removed. GO reduction is performed using hydrazine. The description does not include information about the quality of the flakes produced nor about the yield of the process. CN104528708 presents a process that involves stirring highly concentrated 65% nitric acid with a highly concentrated 98% sulphuric acid at a ratio of 1:3, with an addition of a detergent (oxydol). Thus prepared solution was mixed with graphite, and then an intercalating agent was added which may be one of many oxidants (for example, iron chloride, ammonium nitrate). The stirring process lasts from 4 to 12 h. After stirring graphite, acid and the oxidant, the mixture is subjected to microwaves for 1-5 min and then to ultrasounds for 1 h. The method results in graphene flakes distributed in a slurry. The declared number of layers is in the range of 1-5 and the flakes are characterized by high electrical conductivity and a low number of defects compared to other exfoliation methods. No information on the process yield is provided. In the process according to CN104528708, large amounts of various chemical reagents were used, including an oxidizing agent that may cause defects in the produced material.

In US2014037531, the exfoliation process is presented as carried out under mild oxidizing conditions, with no need of carrying out reduction, and the product is characterized by small structural defects and excellent conductivity. The graphite slurry consists of one or more acids, one or more oxidizing agents and one or more additions of ethanol, benzene, water, methanol, acetone and others. An example process involves stirring graphite, nitric acid, potassium dichromate and water in the ratio of 1:20:10:9 by weight. The whole mixture is subjected to a very high temperature of 900° C., grinding, stirring with ethanol and ultrasonication. The whole process lasts about 7 h. The process yield is estimated at 97%. In US2014037531 Raman spectra of D and G bands are included, but no information is given about the 2D band, i.e. indirectly about the number of layers obtained.

US2010/0028681 describes a possibility of preparing graphene flakes using graphite expanded in a strong acid, with the use of an oxidant at the temperature of about 1000° C., which is then reintercalated in oleum and with a TBA compound. The intercalate is subjected to ultrasounds in the environment of a non-polar, organic chemical compound of DMF or NMP. Additionally, a polymer compound stabilizing graphene flakes is added to the mixture. The process for producing graphene flakes disclosed herein comprises using strong acids and oxidants at very high temperatures as well as using several toxic chemical reagents, such as DMF and TBA. The inventors point out that without the addition of TBA, the process is not efficient and thin graphene flakes cannot be obtained.

The use of oleum according to the invention is defined as a one-day holding of graphite in oleum at room temperature in order to obtain good quality graphene flakes and to avoid excessive functionalisation of the flakes.

Graphite can be exfoliated to the form of graphene using the intercalation phenomenon. In intercalated graphite, distances between the graphene layers are greater than in graphite and, accordingly, van der Waals forces are smaller. This form of graphite is subjected to sonication and is exfoliated. The degree of exfoliation depends on the amount of the intercalate in graphite, sonication strength, liquid in which the process is conducted, and other factors. A very commonly used intercalate is sulphuric acid which is introduced between the graphite layers by means of an oxidant, e.g. nitric acid. Graphite intercalation with the gaseous form of sulphur trioxide is also known, as a result of which a compound of the formula C_{5.8}SO₃ is obtained, wherein distances between the layers are 11.1 Å [Feicht, Patrick & Breu, Josef. (2015). Gas-phase Preparation of SO3-Graphite: Host-Exchange and Exfoliation. Zeitschrift für inorganische und allgemeine Chemie. 641]. However, this product in reaction with water leads to formation of graphite with very large defects. In this case, in order to avoid defects, the intercalate in the form of sulphur trioxide is replaced by an expensive perfluorobutanesulfonic acid.

Most methods of chemical graphite exfoliation in liquids relate to the process of reducing previously formed graphene oxide, wherein oxidation causes large defects in the flakes and significantly reduces process yield. Very high process temperatures, using microwaves, introducing large quantities of various oxidizing compounds, and exploiting many different methods of direct exfoliation, these are all not good ways to exfoliate graphite on a large scale and create a simple, cost-effective and efficient method for producing flaked graphene.

An advantage of the method according to the invention is that the intercalation process does not require to use an oxidant, which helps avoid defects in the graphene structure caused by the activity thereof. Additionally, the absence of an oxidizing agent does not cause a weaker intercalation and exfoliation effect; moreover, it allows to obtain a smaller number of graphene layers. The method yield is 100%, which means that the loss of the material caused by the presence of an oxidant, and thus the oxidation of graphite, has been completely eliminated.

Additionally, the run time of the method did not increase despite the lack of an oxidant as an intercalation aid. According to the invention, only one solution is used—that of sulphuric acid, at various concentrations (oleum—1-60% fuming sulphuric acid and 95-98% sulphuric acid). Thus, the mixture of graphite and oleum is first diluted with sulphuric acid and finally with water, and the temperature range is 20-130 Celsius degrees.

The object of the invention is a method for producing flaked graphene by intercalation and exfoliation of graphite in a liquid, with continuous stirring of the components by sonication, characterized in that oleum is used as the liquid, wherein the concentration of sulphur trioxide in sulphuric acid is 1-60%.

Preferably, the method is carried out in the temperature range of 20-130° C. and not more than 5 g of graphite per 200 ml of oleum is used.

Preferably, the mixture of oleum and graphite is sonicated at the temperature of 80-130° C. for 10-60 h, and the mixture of oleum and graphite after initial sonication is diluted with 95-98% sulphuric acid, in a volume equal to that of oleum used, and with water.

Preferably, water is added in the volume that is not less than a half of the volume of oleum used. Preferably, after adding 95-98% sulphuric acid to the mixture of graphite and oleum, the mixture is stirred by sonication for between 10 hours and 120 hours, and then, after adding water, the mixture is stirred for 12 h.

In a method according to the invention, a solution of sulphur trioxide in sulphuric acid—oleum was used to exfoliate graphite. It turns out that if the process of graphite intercalation with sulphur trioxide is carried out in oleum and simultaneously subjected to ultrasounds (sonication in an ultrasonic bath), then after adding sulphuric acid and water, flaked graphene with a mean thickness of less than 10 layers is obtained with very good quality, and without any defects, as indicated by the Raman spectrum and scanning electron microscope (SEM) and transmission electron microscope (TEM) images. The method is carried out in one vessel at low temperatures in the range of 20-130° C. The method of the present invention does not require the use of any graphite oxidizing agents.

According to the invention, the method for producing flaked graphene by intercalation and exfoliation of graphite in a liquid, with continuous stirring by sonication, is characterized in that oleum (fuming sulphuric acid) is used as a liquid, wherein the concentration of sulphur trioxide in sulphuric acid is 1-60%. In the subsequent method steps, sulphuric acid at the concentration of 95-98% and distilled water are added. The entire method is carried out in the temperature of 20-130° C. Not more than 5 g of graphite per 200 ml of oleum is used.

The mixture of oleum and graphite is maintained at the temperature of 85-130° C. during sonication in an ultrasonic bath, lasting from 10 to 60 h.

The mixture of graphite and oleum is diluted with 95-98% sulphuric acid in a volume equal to that of oleum used. After adding sulphuric acid, the mixture is sonicated from 10 to 120 h before adding water and 12 h after adding water.

Water is added to the mixture in the amount that is not less than a half of the volume of oleum used and, when adding water, the mixture should be cooled to reduce exothermic reactions occurring in the method. The product is separated by filtration and washing, preferably with water and alcohol, preferably with isopropyl alcohol.

The method of intercalation and wet exfoliation of graphite in oleum of the present invention allows for a very efficient production of graphene flakes—up to 100% of crystalline output graphite is converted into thin graphene flakes. The number of layers in the graphene flake decreases exponentially with the decreasing full width at half maximum of the 2D peak in the Raman spectrum [Nacken, Thomas & Damm, Cornelia & Walter, Johannes & Rüger, Andreas & Peukert, Wolfgang. (2015). Delamination of Graphite in a high pressure homogenizer. RSC Adv. 5. 10.1039/C5RA08643D]. The exfoliation product of the invention are graphene layers with a mean thickness below 10 layers, with high quality and a very small degree of defecting. Sonication takes place at low temperatures (below 130° C.), and the entire method comprises only three types of easily accessible equipment: a magnetic stirrer, an ultrasonic bath and a filtration kit. The intercalation and exfoliation process of the invention is carried out without the addition of any oxidizing agents or other additional chemical compounds. An important feature of the method is that the intercalation and exfoliation process occurs simultaneously during sonication of the oleum and graphite mixture. The addition of sulphuric acid to the mixture of oleum and graphite increases the exfoliation effect by increasing the volume of the mixture. The dilution of oleum characterized by high density by means of adding sulphuric acid and then water results in the creation of additional space for the exfoliation of graphene flakes.

The evaluation of the quality of the graphene flakes produced by the method of the invention was performed on the basis of the results presented in the drawings, in which:

FIG. 1a shows a single Raman spectrum of the graphene flakes of the graphene obtained by the method described in Example 1 with a mean thickness of 3-4 layers.

FIG. 1b shows a statistical analysis of full width at half maximum (FWHM) of the 2D band for graphene with a mean value of 62.8 cm⁻¹, which is characteristic for the flakes about 3-4 layers' thick. The value range from 55 cm⁻¹ to 70 cm⁻¹ is characteristic for 2-20 layers, respectively.

FIG. 1c shows a statistical analysis of the surface area ratio of 2D/G peaks for graphene with a mean value of 1.24.

FIG. 1d shows a statistical analysis of the intensity ratio of D/G peaks for graphene with a mean value of 0.23.

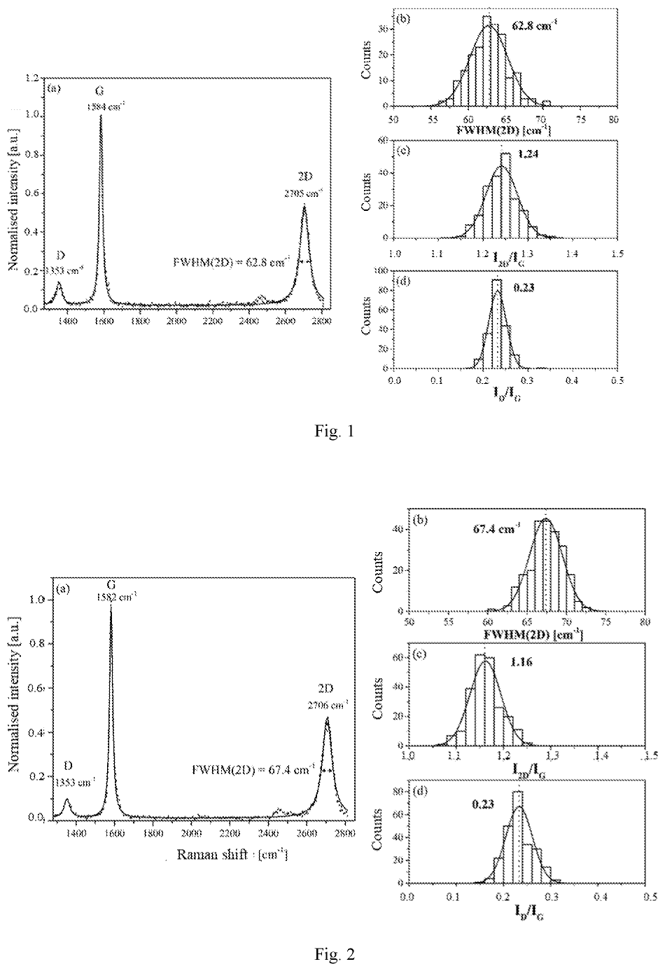

FIG. 2a shows a single Raman spectrum of the graphene flakes after the exfoliation process of Example 2 with a mean thickness of 8 layers.

FIG. 2b shows a statistical analysis of full width at half maximum of the 2D band for graphene with a mean value of 67.4 cm⁻¹, which is characteristic for the flakes about 8 layers' thick.

FIG. 2c shows a statistical analysis of the surface area ratio of 2D/G peaks for graphene with a mean value of 1.16.

FIG. 2d shows a statistical analysis of the intensity ratio of D/G peaks for graphene with a mean value of 0.23.

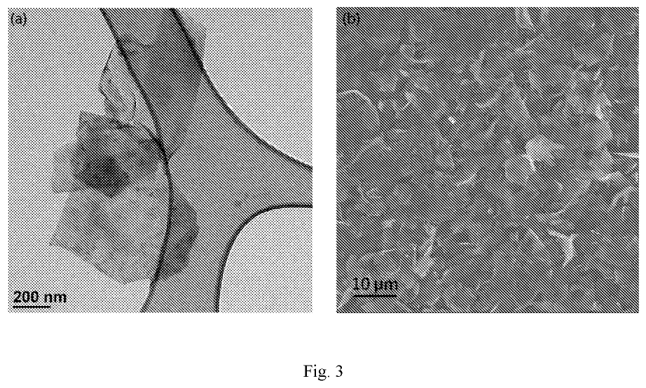

FIG. 3a shows images taken by a transmission electron microscope (TEM), in which the structure of individual graphene flakes can be seen.

FIG. 3b shows images taken with a scanning electron microscope (SEM) in which the structure of multiple graphene flakes can be seen.

The method of the invention is presented in more detail in the following embodiments which are intended to illustrate the invention, but not to limit it.

### EXAMPLE 1

A mixture containing 1 gram of Acros Organics graphite powder and 200 ml of oleum, wherein the sulphur trioxide concentration in sulphuric acid is 30% was heated for 2 h at 130° ° C.and then sonicated for 24 h in an ultrasonic bath with the ultrasonic frequency of 80kHz at the temperature of 85° C. Then, 200 mL of 98% sulphuric acid was added and sonicated for 100 h in the ultrasonic bath at the ultrasonic frequency of 80 Khz and at the temperature of 85° C. Subsequently, 200 mL of deionized water was poured into the mixture and the mixture was sonicated for 12 h. The process of adding water and sonication for 12 h was repeated twice. After sonication, the mixture was further subjected to vacuum filtration. After filtration, graphene was washed with water and isopropyl alcohol until the filtered solution became neutral. Graphene was then dried. The yield of this method was 100%-1.0 g of graphene flakes was obtained. The obtained graphene flakes had a mean thickness of 3-4 layers.

### EXAMPLE 2

A mixture containing 1 gram of Acros Organics graphite powder and 200 ml of oleum, wherein the sulphur trioxide concentration in sulphuric acid was 30% was heated for 1 h at 130° ° C.and then sonicated for 12 h in an ultrasonic bath with the ultrasonic frequency of 80 kHz at the temperature of 85° C. Then, 200 mL of 98% sulphuric acid was added and sonicated for 12 h in the ultrasonic bath at the ultrasonic frequency set at 80 Khz and at the temperature of 85° C. Next, 100 mL of deionized water was poured into the mixture and the mixture was sonicated for 12 h. The process of adding water and sonication for 12 h was repeated twice. After sonication, the mixture was further subjected to vacuum filtration. After filtration, graphene was washed with water and isopropyl alcohol until the filtered solution became neutral. Graphene was then dried. The yield of this method was 100%-1.0 g of graphene flakes was obtained. The obtained graphene flakes had a mean thickness of 8 layers.

1. A method for producing flaked graphene by intercalation and exfoliation of graphite in a liquid, with continuous stirring of the components by sonication, characterized in that oleum is used as the liquid, wherein the concentration of sulphur trioxide in sulphuric acid is 1-60%.

2. The method according to claim 1, characterized in that the method is carried out in a temperature range of 20-130° C.

3. The method according to claim 1, characterized in that not more than 5 g of graphite per 200 ml of oleum is used.

4. The method according to claim 1, characterized in that the mixture of oleum and graphite is subjected to sonication at the temperature of 80-130° C. for 10-60 h.

5. The method according to claim 4, characterized in that the mixture of oleum and graphite after initial sonication is diluted with 95-98% sulphuric acid, in a volume equal to that of oleum used, and with water.

6. The method according to claim 5, characterized in that water is added in the volume that is not less than a half of the volume of oleum used.

7. The method according to claim 5, characterized in that after adding 95-98% sulphuric acid to the mixture of graphite and oleum, the mixture is stirred by sonication for between 10 hours and 120 hours, and then, after adding water, the mixture is stirred for 12 h.
